(19) United States
(12) Patent Application Publication
(10) Pub. No.: US 2023/0084635 A1
(43) Pub. Date: Mar. 16, 2023

(54) SYSTEMS AND METHODS FOR ACCESSING ONLINE MEETING MATERIALS

(71) Applicant: Citrix Systems, Inc., Fort Lauderdale, FL (US)

(72) Inventors: Ke Xu, Nanjing (CN); Zhaozhao Xiong, Nanjing (CN); Jian Luo, Nanjing (CN); Jiabin Shan, Nanjing (CN)

(21) Appl. No.: 17/512,735

(22) Filed: Oct. 28, 2021

Related U.S. Application Data
(63) Continuation of application No. PCT/CN2021/118120, filed on Sep. 14, 2021.

(51) Int. Cl. G06F 16/28; G06F 16/2457; H04L 12/18; G06F 3/0482

(52) U.S. Cl. CPC G06F 16/287; G06F 16/24575; H04L 12/1831; G06F 3/0482

(57) ABSTRACT

According to some embodiments, a method can include: collecting, by a first computing device, materials associated with a meeting; generating, by the first computing device, graph data for the meeting based on the collected materials, the graph data including representations of the collected materials and of relationships between the collected materials; and sending, by the first computing device, the graph data for the meeting to a second computing device, the second computing device configured to display a graph of the meeting using the graph data.

### CROSS REFERENCE TO RELATED APPLICATIONS

This application is a continuation of and claims the benefit of and priority to Patent Application No. PCT/CN2021/118120 filed on Sep. 14, 2021, the contents of which is hereby incorporated herein by reference in its entirety.

### BACKGROUND

Organizations schedule meetings for a variety of reasons. For example, within a company, employees within the same division may attend monthly planning meetings, weekly “check in” meetings, etc. In addition to regularly scheduled meetings, employees or other persons associated with an organization (“associates”) may attend stand-alone meetings to discuss time-sensitive matters. It is not uncommon for an employee to attend several meetings in the same day or dozens of meetings in the same week. An organization may use a calendaring service, such as EXCHANGE, to coordinate meeting information among its associates. The associates of the organization may use a compatible calendar application, such as OUTLOOK, to view and manage meetings they are schedule to attend.

Online or “virtual” meetings are an increasingly popular way for people to collaborate, particularly when they are in different physical locations. In addition to providing audio and video conferencing, online meeting services (or “meeting services” for short) such as TEAMS, ZOOM, and GOTOMEETING may include features for sharing other types of information related to meeting, generally referred to herein as “meeting materials.” For example, some meeting services allow participants to upload files (e.g., a meeting agenda or other relevant documents) that can be downloaded or otherwise accessed by other participants. As another example, some meeting services allow participants to manually enter/upload meeting minutes that can be viewed/downloaded by the meeting's participants. Certain meeting services may include a feature to automatically generate meeting minutes based on the contents of the meeting. As another example, some meeting services allow the participants to send and receive chat messages that can include text, images, etc. to and from other participants. As yet another example, some meeting services allow participants to link to external resources within the meeting by entering a uniform resource locator (URL) associated with a software-as-a-service (SaaS) application. For example, a user may link a particular JIRA ticket to a given online meeting.

### SUMMARY

It is appreciated herein that it can be difficult and/or time consuming to access materials for meetings that occurred in the past using existing systems. For example, an employee may attend dozens of meetings per week and each meeting may have its own handouts and minutes distributed via a calendaring service, a meeting service, and/or an email service. To access all materials for a particular meeting, a user may have to launch multiple applications on their device (e.g., a calendar application, a meeting application, and/or an email application) and then search for meeting materials within each of those applications using keywords, date ranges, or other search criteria. This can be inefficient in terms of computing resources and user productivity and such inefficiencies can be compounded when accessing materials for multiple meeting (e.g., a series of related meetings).

The present disclosure relates to systems and methods for automatically collecting and presenting materials and other meeting information in a graphical format referred to as a “meeting graph.” A meeting graph can include nodes corresponding to meetings, participants, messages, documents, minutes, external links, and/or other types of meeting materials and can include vertices corresponding to relationships between such meeting information. Meeting graphs can be visually rendered/displayed on client devices and a user can interact with a visual meeting graph to easily access materials for a single meeting or for a series of related meetings. The techniques described herein can be used to improve the efficiency and utility of existing computer systems and applications. For example, disclosed embodiments can significantly reduce the amount of time required for a user to locate meeting materials as well as reducing the amount of network and/or processing resources required to perform such a search.

According to one aspect of the present disclosure, a method can include: collecting, by a first computing device, materials associated with a meeting; generating, by the first computing device, graph data for the meeting based on the collected materials, the graph data including representations of the collected materials and of relationships between the collected materials; and sending, by the first computing device, the graph data for the meeting to a second computing device, the second computing device configured to display a graph of the meeting using the graph data.

In some embodiments, the collecting of the materials associated with the meeting may include collecting the materials from an online meeting service, and the method can further include retrieving scheduling information for the meeting from a calendaring service from the online meeting service, wherein the generating of the graph data for the meeting is further based on the scheduling information. In some embodiments, the method can include: storing the scheduling information and the collected materials in a structured database; and storing the graph data in a graph database separate from the structured database. In some embodiments, the method can include: obtaining a rendering of the graph of the meeting from the graph database; and providing the rendering of the graph of the meeting to the second computing device, the second computing device configured to display the rendering of the graph of the meeting.

In some embodiments, the collected materials may include information about participants of the meeting, wherein the graph data can include representations of the participants of the meeting. In some embodiments, the collected materials can include chat messages sent during the meeting, wherein the graph data may include representations of the chat messages. In some embodiments, the method can include: receiving, by the first computing device, a request to upload a file for the meeting; and storing contents of the file in the structured database, wherein the graph data includes a representation of the file.

In some embodiments, the method can include: receiving, by the first computing device, a request for information about meetings related to the meeting; retrieving scheduling information for other meetings from the calendaring service; identifying at least one of the other meetings that is related to the meeting using the scheduling information for the meeting and the scheduling information for other meetings; and sending, by the first computing device, a response including materials for the at least one of the other meetings that is related to the meeting. In some embodiments, identifying the at least one of the other meetings that is related to the meeting can include: extracting one or more keywords from the scheduling information for the meeting; receiving trained word vectors for the one or more keywords; for each of the other meetings: generating a sentence vector based on the scheduling information for the other meeting, and calculating a similarity between the sentence vector and the trained word vectors; and identifying the at least one of the other meetings that is related to the meeting based on the calculated similarities.

According to another aspect of the present disclosure, a system can include a processor and a non-volatile memory storing computer program code that when executed on the processor causes the processor to execute a process. The process can be operable to: collect materials associated with a meeting; generate graph data for the meeting based on the collected materials, the graph data including representations of the collected materials and of relationships between the collected materials; and send the graph data for the meeting to a client device, the client device configured to display a graph of the meeting using the graph data.

According to another aspect of the present disclosure, a non-transitory computer readable medium can store program instructions that are executable to: collect materials associated with a meeting; generate graph data for the meeting based on the collected materials, the graph data including representations of the collected materials and of relationships between the collected materials; and send the graph data for the meeting to a client device, the client device configured to display a graph of the meeting using the graph data.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4A is a block diagram of an example system in which resource management services may manage and streamline access by clients to resource feeds (via one or more gateway services) and/or software-as-a-service (SaaS) applications.

FIG. 4B is a block diagram showing an example implementation of the system shown in FIG. 4A in which various resource management services as well as a gateway service are located within a cloud computing environment.

FIG. 4C is a block diagram similar to that shown in FIG. 4B but in which the available resources are represented by a single box labeled “systems of record,” and further in which several different services are included among the resource management services.

FIG. 5 is block diagram of a system for efficiently accessing meeting materials, according to some embodiments of the present disclosure.

FIG. 6 is a diagram illustrating a portion of a structured database schema that can be used within the system of FIG. 5, according to some embodiments.

FIG. 7A is a diagram illustrating meeting graph data that can be generated and stored within the system of FIG. 5, according to some embodiments.

FIG. 7B is a diagram illustrating a portion of a visual meeting graph that can be generated from the meeting graph data of FIG. 7A, according to some embodiments.

FIGS. 8A-8E are diagrams of an illustrative user interface (UI) that can be used within the system of FIG. 5, according to some embodiments.

FIG. 9 is a flow diagram showing an illustrative process for identifying related meetings, according to embodiments of the present disclosure.

FIG. 10 is a flow diagram showing an illustrative process for providing efficient access to meeting materials, according to embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

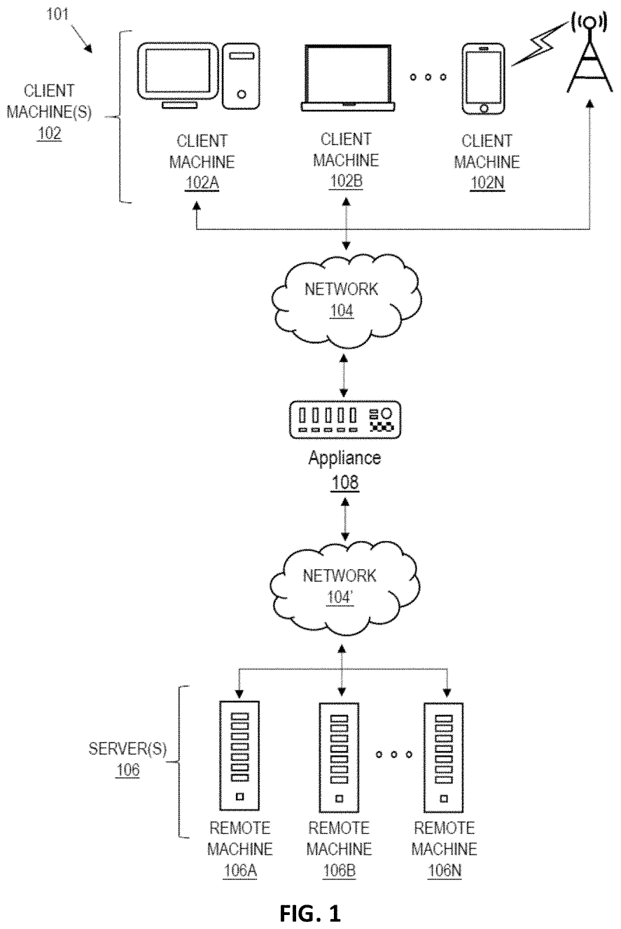

Referring now to FIG. 1, shown is an example network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

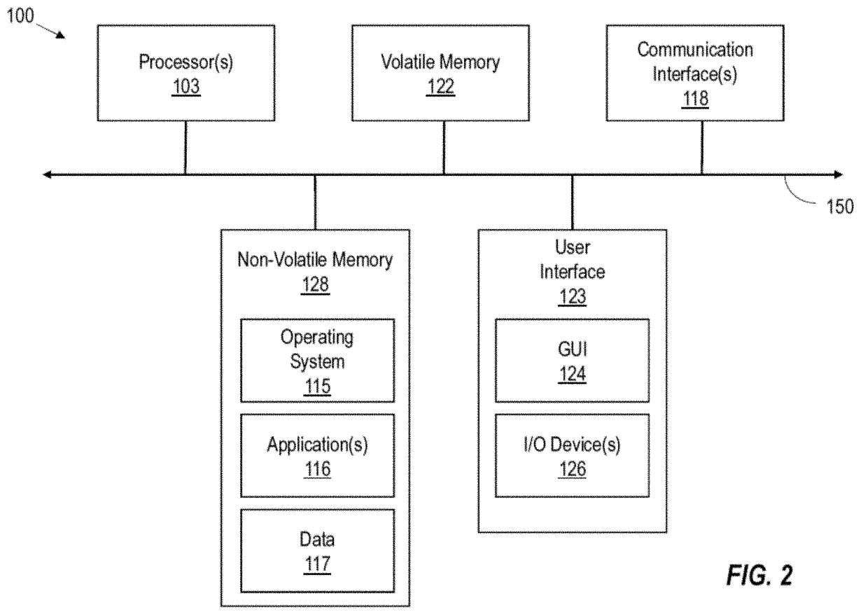

FIG. 2 is a block diagram illustrating selective components of an example computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an example client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed-signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

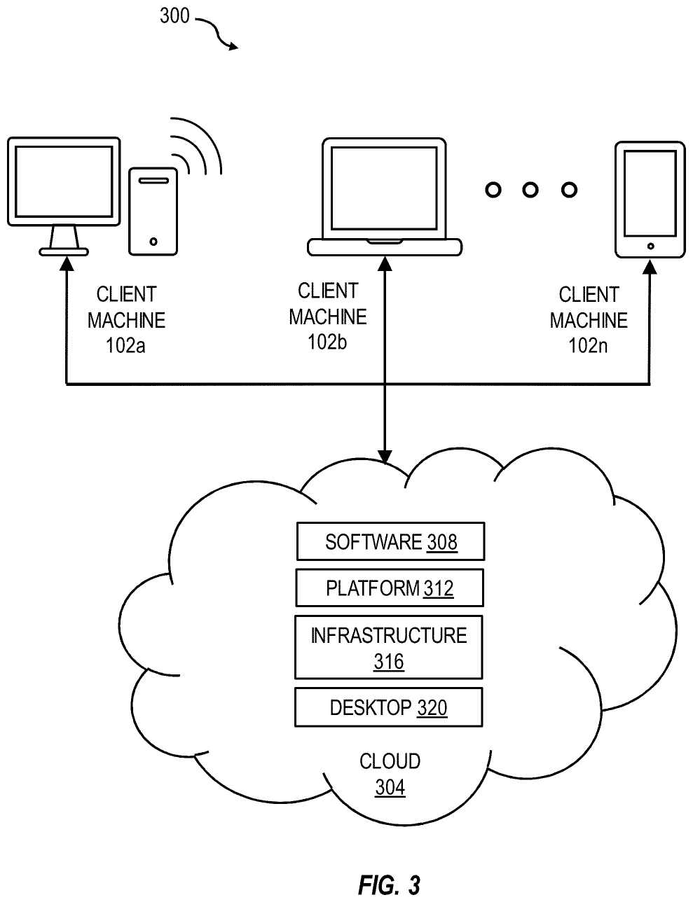

Referring to FIG. 3, a cloud computing environment 300 is depicted, which may also be referred to as a cloud environment, cloud computing or cloud network. The cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 300, one or more clients 102a-102n (such as those described above) are in communication with a cloud network 304. The cloud network 304 may include back-end platforms, e.g., servers, storage, server farms or data centers. The users or clients 102a-102n can correspond to a single organization/tenant or multiple organizations/tenants. More particularly, in one example implementation the cloud computing environment 300 may provide a private cloud serving a single organization (e.g., enterprise cloud). In another example, the cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 300 may provide a hybrid cloud that is a combination of a public cloud and a private cloud. Public clouds may include public servers that are maintained by third parties to the clients 102a-102n or the enterprise/tenant. The servers may be located off-site in remote geographical locations or otherwise.

The cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 300 can provide an elasticity to dynamically scale out or scale in response to different demands from one or more clients 102. In some embodiments, the cloud computing environment 300 can include or provide monitoring services to monitor, control and/or generate reports corresponding to the provided shared services and resources.

In some embodiments, the cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

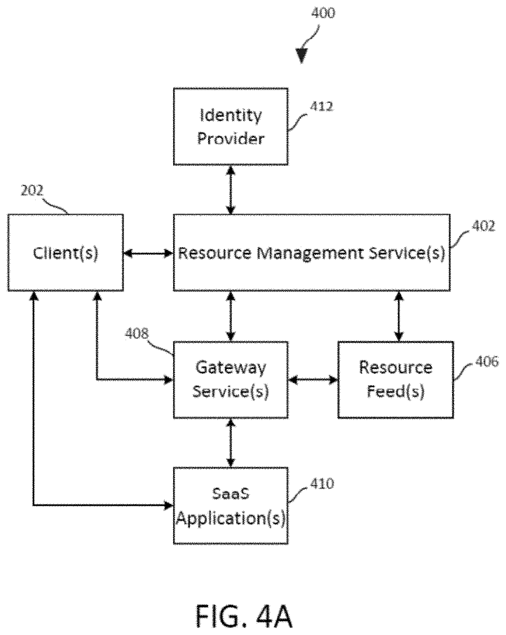

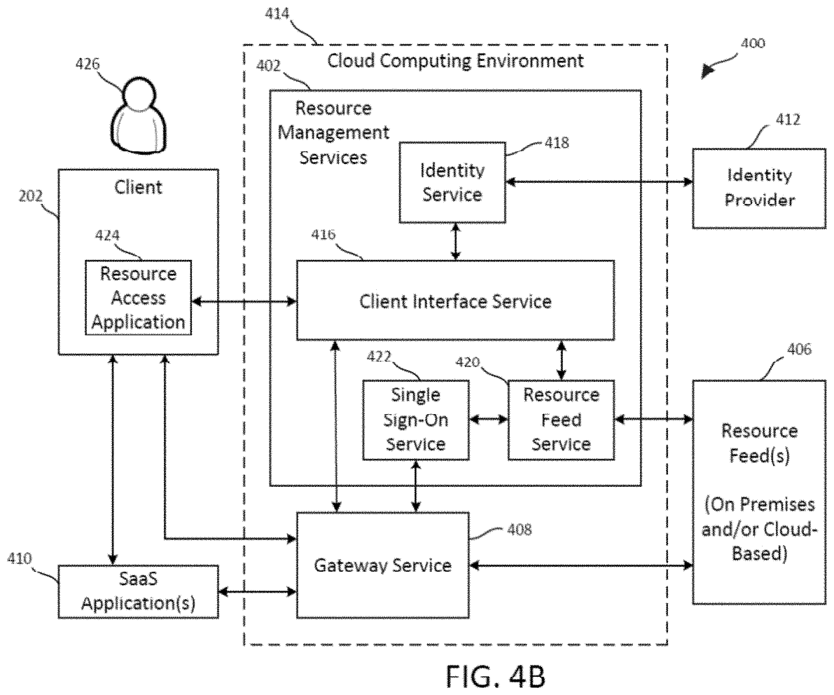

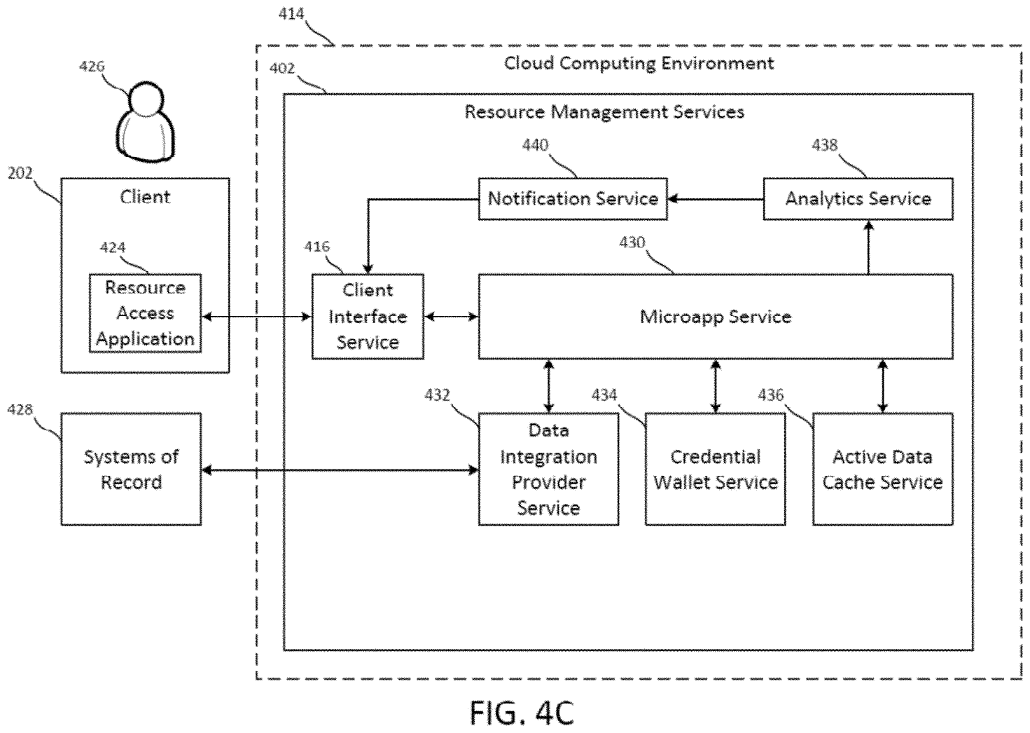

FIG. 4A is a block diagram of an example system 400 in which one or more resource management services 402 may manage and streamline access by one or more clients 202 to one or more resource feeds 406 (via one or more gateway services 408) and/or one or more software-as-a-service (SaaS) applications 410. In particular, the resource management service(s) 402 may employ an identity provider 412 to authenticate the identity of a user of a client 202 and, following authentication, identify one of more resources the user is authorized to access. In response to the user selecting one of the identified resources, the resource management service(s) 402 may send appropriate access credentials to the requesting client 202, and the client 202 may then use those credentials to access the selected resource. For the resource feed(s) 406, the client 202 may use the supplied credentials to access the selected resource via a gateway service 408. For the SaaS application(s) 410, the client 202 may use the credentials to access the selected application directly.

The client(s) 202 may be any type of computing devices capable of accessing the resource feed(s) 406 and/or the SaaS application(s) 410, and may, for example, include a variety of desktop or laptop computers, smartphones, tablets, etc. The resource feed(s) 406 may include any of numerous resource types and may be provided from any of numerous locations. In some embodiments, for example, the resource feed(s) 406 may include one or more systems or services for providing virtual applications and/or desktops to the client(s) 202, one or more file repositories and/or file sharing systems, one or more secure browser services, one or more access control services for the SaaS applications 410, one or more management services for local applications on the client(s) 202, one or more internet enabled devices or sensors, etc. Each of the resource management service(s) 402, the resource feed(s) 406, the gateway service(s) 408, the SaaS application(s) 410, and the identity provider 412 may be located within an on-premises data center of an organization for which the system 400 is deployed, within one or more cloud computing environments, or elsewhere.

FIG. 4B is a block diagram showing an example implementation of the system 400 shown in FIG. 4A in which various resource management services 402 as well as a gateway service 408 are located within a cloud computing environment 414. The cloud computing environment may, for example, include Microsoft Azure Cloud, Amazon Web Services, Google Cloud, or IBM Cloud.

For any of illustrated components (other than the client 202) that are not based within the cloud computing environment 414, cloud connectors (not shown in FIG. 4B) may be used to interface those components with the cloud computing environment 414. Such cloud connectors may, for example, run on Windows Server instances hosted in resource locations and may create a reverse proxy to route traffic between the site(s) and the cloud computing environment 414. In the illustrated example, the cloud-based resource management services 402 include a client interface service 416, an identity service 418, a resource feed service 420, and a single sign-on service 422. As shown, in some embodiments, the client 202 may use a resource access application 424 to communicate with the client interface service 416 as well as to present a user interface on the client 202 that a user 426 can operate to access the resource feed(s) 406 and/or the SaaS application(s) 410. The resource access application 424 may either be installed on the client 202, or may be executed by the client interface service 416 (or elsewhere in the system 400) and accessed using a web browser (not shown in FIG. 4B) on the client 202.

As explained in more detail below, in some embodiments, the resource access application 424 and associated components may provide the user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 424 is launched or otherwise accessed by the user 426, the client interface service 416 may send a sign-on request to the identity service 418. In some embodiments, the identity provider 412 may be located on the premises of the organization for which the system 400 is deployed. The identity provider 412 may, for example, correspond to an on-premises Windows Active Directory. In such embodiments, the identity provider 412 may be connected to the cloud-based identity service 418 using a cloud connector (not shown in FIG. 4B), as described above. Upon receiving a sign-on request, the identity service 418 may cause the resource access application 424 (via the client interface service 416) to prompt the user 426 for the user's authentication credentials (e.g., user-name and password). Upon receiving the user's authentication credentials, the client interface service 416 may pass the credentials along to the identity service 418, and the identity service 418 may, in turn, forward them to the identity provider 412 for authentication, for example, by comparing them against an Active Directory domain. Once the identity service 418 receives confirmation from the identity provider 412 that the user's identity has been properly authenticated, the client interface service 416 may send a request to the resource feed service 420 for a list of subscribed resources for the user 426.

In other embodiments (not illustrated in FIG. 4B), the identity provider 412 may be a cloud-based identity service, such as a Microsoft Azure Active Directory. In such embodiments, upon receiving a sign-on request from the client interface service 416, the identity service 418 may, via the client interface service 416, cause the client 202 to be redirected to the cloud-based identity service to complete an authentication process. The cloud-based identity service may then cause the client 202 to prompt the user 426 to enter the user's authentication credentials. Upon determining the user's identity has been properly authenticated, the cloud-based identity service may send a message to the resource access application 424 indicating the authentication attempt was successful, and the resource access application 424 may then inform the client interface service 416 of the successfully authentication. Once the identity service 418 receives confirmation from the client interface service 416 that the user's identity has been properly authenticated, the client interface service 416 may send a request to the resource feed service 420 for a list of subscribed resources for the user 426.

For each configured resource feed, the resource feed service 420 may request an identity token from the single sign-on service 422. The resource feed service 420 may then pass the feed-specific identity tokens it receives to the points of authentication for the respective resource feeds 406. Each resource feed 406 may then respond with a list of resources configured for the respective identity. The resource feed service 420 may then aggregate all items from the different feeds and forward them to the client interface service 416, which may cause the resource access application 424 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 410 to which the user 426 has subscribed. The lists of local applications and the SaaS applications 410 may, for example, be supplied by resource feeds 406 for respective services that manage which such applications are to be made available to the user 426 via the resource access application 424. Examples of SaaS applications 410 that may be managed and accessed as described herein include Microsoft Office 365 applications, SAP SaaS applications, Workday applications, etc.

For resources other than local applications and the SaaS application(s) 410, upon the user 426 selecting one of the listed available resources, the resource access application 424 may cause the client interface service 416 to forward a request for the specified resource to the resource feed service 420. In response to receiving such a request, the resource feed service 420 may request an identity token for the corresponding feed from the single sign-on service 422. The resource feed service 420 may then pass the identity token received from the single sign-on service 422 to the client interface service 416 where a launch ticket for the resource may be generated and sent to the resource access application 424. Upon receiving the launch ticket, the resource access application 424 may initiate a secure session to the gateway service 408 and present the launch ticket. When the gateway service 408 is presented with the launch ticket, it may initiate a secure session to the appropriate resource feed and present the identity token to that feed to seamlessly authenticate the user 426. Once the session initializes, the client 202 may proceed to access the selected resource.

When the user 426 selects a local application, the resource access application 424 may cause the selected local application to launch on the client 202. When the user 426 selects a SaaS application 410, the resource access application 424 may cause the client interface service 416 request a one-time uniform resource locator (URL) from the gateway service 408 as well a preferred browser for use in accessing the SaaS application 410. After the gateway service 408 returns the one-time URL and identifies the preferred browser, the client interface service 416 may pass that information along to the resource access application 424. The client 202 may then launch the identified browser and initiate a connection to the gateway service 408. The gateway service 408 may then request an assertion from the single sign-on service 422. Upon receiving the assertion, the gateway service 408 may cause the identified browser on the client 202 to be redirected to the logon page for identified SaaS application 410 and present the assertion. The SaaS may then contact the gateway service 408 to validate the assertion and authenticate the user 426. Once the user has been authenticated, communication may occur directly between the identified browser and the selected SaaS application 410, thus allowing the user 426 to use the client 202 to access the selected SaaS application 410.

In some embodiments, the preferred browser identified by the gateway service 408 may be a specialized browser embedded in the resource access application 424 (when the resource application is installed on the client 202) or provided by one of the resource feeds 406 (when the resource application 424 is located remotely), e.g., via a secure browser service. In such embodiments, the SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have the client interface service 416 send the link to a secure browser service, which may start a new virtual browser session with the client 202, and thus allow the user to access the potentially harmful linked content in a safe environment.

In some embodiments, in addition to or in lieu of providing the user 426 with a list of resources that are available to be accessed individually, as described above, the user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for a client 202. In the example shown, in addition to the client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 424 without having to launch the native application. The system shown in FIG. 4C may, for example, aggregate relevant notifications, tasks, and insights, and thereby give the user 426 a dynamic productivity tool. In some embodiments, the resource activity feed may be intelligently populated by utilizing machine learning and artificial intelligence (AI) algorithms. Further, in some implementations, microapps may be configured within the cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, the systems of record 428 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 432, may, for example, support REST API, JSON, OData-JSON, and 6ML. As explained in more detail below, the data integration provider service 432 may also write back to the systems of record, for example, using OAuth2 or a service account.

In some embodiments, the microapp service 430 may be a single-tenant service responsible for creating the microapps. The microapp service 430 may send raw events, pulled from the systems of record 428, to the analytics service 438 for processing. The microapp service may, for example, periodically pull active data from the systems of record 428.

In some embodiments, the active data cache service 436 may be single-tenant and may store all configuration information and microapp data. It may, for example, utilize a per-tenant database encryption key and per-tenant database credentials.

In some embodiments, the credential wallet service 434 may store encrypted service credentials for the systems of record 428 and user OAuth2 tokens.

In some embodiments, the data integration provider service 432 may interact with the systems of record 428 to decrypt end-user credentials and write back actions to the systems of record 428 under the identity of the end-user. The write-back actions may, for example, utilize a user's actual account to ensure all actions performed are compliant with data policies of the application or other resource being interacted with.

In some embodiments, the analytics service 438 may process the raw events received from the microapps service 430 to create targeted scored notifications and send such notifications to the notification service 440.

Finally, in some embodiments, the notification service 440 may process any notifications it receives from the analytics service 438. In some implementations, the notification service 440 may store the notifications in a database to be later served in a notification feed. In other embodiments, the notification service 440 may additionally or alternatively send the notifications out immediately to the client 202 as a push notification to the user 426.

In some embodiments, a process for synchronizing with the systems of record 428 and generating notifications may operate as follows. The microapp service 430 may retrieve encrypted service account credentials for the systems of record 428 from the credential wallet service 434 and request a sync with the data integration provider service 432. The data integration provider service 432 may then decrypt the service account credentials and use those credentials to retrieve data from the systems of record 428. The data integration provider service 432 may then stream the retrieved data to the microapp service 430. The microapp service 430 may store the received systems of record data in the active data cache service 436 and also send raw events to the analytics service 438. The analytics service 438 may create targeted scored notifications and send such notifications to the notification service 440. The notification service 440 may store the notifications in a database to be later served in a notification feed and/or may send the notifications out immediately to the client 202 as a push notification to the user 426.

In some embodiments, a process for processing a user-initiated action via a microapp may operate as follows. The client 202 may receive data from the microapp service 430 (via the client interface service 416) to render information corresponding to the microapp. The microapp service 430 may receive data from the active data cache service 436 to support that rendering. The user 426 may invoke an action from the microapp, causing the resource access application 424 to send that action to the microapp service 430 (via the client interface service 416). The microapp service 430 may then retrieve from the credential wallet service 434 an encrypted Oauth2 token for the system of record for which the action is to be invoked, and may send the action to the data integration provider service 432 together with the encrypted Oath2 token. The data integration provider service 432 may then decrypt the Oath2 token and write the action to the appropriate system of record under the identity of the user 426. The data integration provider service 432 may then read back changed data from the written-to system of record and send that changed data to the microapp service 430. The microapp service 432 may then update the active data cache service 436 with the updated data and cause a message to be sent to the resource access application 424 (via the client interface service 416) notifying the user 426 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 402 may, for example, parse these requests and respond because they are integrated with multiple systems on the back-end. In some embodiments, users may be able to interact with the virtual assistance through either the resource access application 424 or directly from another resource, such as Microsoft Teams. This feature may allow employees to work efficiently, stay organized, and deliver only the specific information being sought.

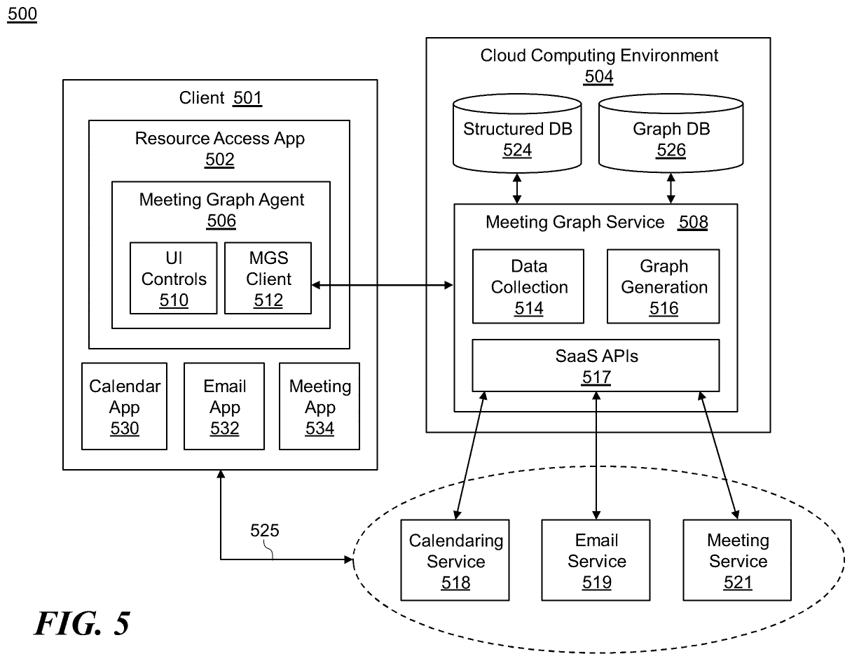

FIG. 5 shows a system for efficiently accessing meeting materials, according to some embodiments. Illustrative system 500 includes a resource access application 502 installed on a client 501 and configured to communicate with a cloud computing environment 504. Client 501, resource access application 502, and cloud computing environment 504 of FIG. 5 can be the same as or similar to client 202, resource access application 424, and cloud computing environment 414, respectively, of FIGS. 4A-4C.

A meeting graph agent 506 can be provided as a sub-module or other component of resource access application 502. A meeting graph service 508 can be provided as a service (e.g., a microservice) within the cloud clouding environment 504. Meeting graph agent 506 and meeting graph service 508 can interoperate to automatically collect and organize meeting materials and to visually render/display meeting materials and other meeting information as meeting graphs. In more detail, meeting graph service 508 can collect and organize meeting information into a data format (referred to herein as “meeting graph data”) that can be rendered/displayed by meeting graph agent 506 as a graph having nodes and vertices (referred to herein as a “visual meeting graph”). A user of client 501 can view and interact with visual meeting graphs within resource access app 502 to efficiently access meeting materials.

To promote clarity in the drawings, FIG. 5 shows a single resource access application 502 connected to meeting graph service 508. However, embodiments of meeting graph service 508 can be used to service many resource access applications 502 used by many different users associated with one or more organizations. Meeting graph agent 506 and/or meeting graph service 508 may be implemented as computer instructions executable to perform the corresponding functions disclosed herein.

Meeting graph agent 506 and meeting graph service 508 can be logically and/or physically organized into one or more components. In the example of FIG. 5, meeting graph agent 506 includes UI controls 510 and a meeting graph service (MGS) client 512. Also in this example, meeting graph service 508 includes a data collection module 514, a graph generation module 516, and one or more SaaS application programming interface (API) modules 517.

The client-side meeting graph agent 506 and cloud-side meeting graph service 508 can communicate using an API. For example, meeting graph agent 506 can utilize MGS client 512 to send API requests (or “messages”) to meeting graph service 508 and meeting graph service 508 can send API responses/messages back to meeting graph agent 506, wherein the API responses are received and processed by MGS client 512.

In addition to resource access application 502, various other applications can be installed on client 501, such as a calendar application 530, an email application 532, and a meeting application 534. Calendar application 530, email application 532, and meeting application 534 can communicate with a calendaring service 518, an email service 519, and a meeting service 521, respectively, as illustrated by line 525. In some embodiments, calendar application 530 and email application 532 can correspond to a single application (e.g., OUTLOOK) that provides both calendaring and email functionality. Meeting application 534 and meeting service 521 may correspond to, for example, TEAMS, ZOOM, GOTOMEETING, or another online meeting application and service. In some embodiments, applications 530, 532, and/or 534 can access services 518, 519, and/or 521 using a single sign-on service (e.g., service 422 of FIG. 4B).

Referring to meeting graph service 508, data collection module 514 is operable to retrieve meeting materials and other meeting information from one or more calendaring services (e.g., calendaring service 518), one or more email services (e.g., email service 519), and one or more meeting services (e.g., meeting service 521). In some embodiments, calendaring service 518 and email service 519 may correspond to a common system/service that provides both calendaring and email services, such as EXCHANGE. In other embodiments, calendaring service 518 an email service 519 may correspond to separate systems/services. In some embodiments, meeting graph service 508 can access services 518, 519, and/or 521 using a single sign-on service (e.g., service 422 of FIG. 4B). Services 518, 519, 521 can be hosted within a cloud computing environment (e.g., cloud computing environment 504 or a different cloud computing environment) or within an on-premises data center (e.g., an on-premises data center of an organization that utilizes meeting graph service 508).

Data collection module 514 may communicate with services 518, 519, 521 using SaaS API modules 517. In more detail, SaaS API modules 517 can include client-side implementations of APIs provided by services 518, 519, 521 to query/retrieve meeting materials and other meeting information therefrom. For example, SaaS API modules 517 may include client-side implementations of MICROSOFT GRAPH APIs to retrieve meeting materials and other meeting information from EXCHANGE and/or TEAMS (e.g., from calendaring service 518, email service 519, and/or meeting service 521). As another example, SaaS API modules 517 may include client-side implementations of a ZOOM API for to retrieving meeting materials and other meeting information from ZOOM (e.g., from meeting service 521). In some embodiments, SaaS API modules 517 may include client-side implementations of one or more RESTful APIs and/or Remote Procedure Call (RPC)-based APIs.

The particular services from which data collection module 514 can retrieve meeting information can vary between different organizations and/or between different users of the same organization. In some embodiments, data collection module 514 can obtain a list of services used by a particular organization and/or user. For example, some organizations serviced by meeting graph service 508 may use ZOOM as a meeting service 521 whereas other organizations may use TEAMS. Data collection module 514 can determine which services to collect meeting information from based on configuration information maintained for an organization and/or user. In some embodiments, data collection module 514 may obtain a list of subscribed resources (e.g., applications and services) for a particular user/organization via resource feed service 420 of FIG. 4B. Data collection module 514 may also obtain, for one or more users, authentication credentials (e.g., user ids and passwords, access tokens, etc.) needed to access one of more of the services for collecting meeting information. In some embodiments, data collection module 514 may use a single sign-on service (e.g., service 422 of FIG. 4B) to access one or more such services.

Data collection module 514 can retrieve scheduled meeting information from calendaring service 518. Scheduled meeting information (or “meeting scheduling information”) can include, for a particular meeting, information such as time meeting's start time, end time, title, description, and a list of meeting participants (e.g., a list of name and/or email addresses of the meeting's participants). These examples of scheduled meeting information are merely illustrative and may vary depending on the capabilities of calendaring service 518.

Data collection module 514 can use scheduled meeting information retrieved from calendaring service 518 to determine if a scheduled meeting is an online meeting, i.e., if it corresponds to a meeting hosted using an online meeting service 521. Online meeting services such as TEAMS and ZOOM may generate a unique URL for each online meeting hosted thereon. A meeting organizer may include the online meeting URL within the description of a meeting scheduled via calendaring service 518 such that meeting participants can join the online meeting using the URL (e.g., by clicking on a link within a calendar application 530). Thus, in some embodiments, data collection module 514 can retrieve the description of a scheduled meeting from calendaring service 518 and parse/scan the meeting description to extract the online meeting URL, if any. An online meeting URL may include a unique numeric or alphanumeric identifier for the online meeting and, in some embodiments, data collection module 514 may extract the unique identifier for the online meeting from the online meeting URL. Other techniques can be used to determine if a scheduled meeting within calendaring service 518 corresponds to an online meeting within meeting service 521.

For one or more meetings, data collection module 514 can retrieve meeting materials (e.g., files uploaded to the meeting service, meeting minutes, chat messages, links to external applications, etc.) from meeting service 521. For example, using an API provided by meeting service 521, data collection module 514 may retrieve materials associated with a particular online meeting (e.g., using a unique TEAMS or ZOOM meeting identifier obtained from calendaring service 518, as previously discussed). In some embodiments, data collection module 514 may also query email service 519 for relevant meeting materials using, for example, by performing keyword searches based on the meeting's title or description. In some embodiments, data collection module 514 can retrieve scheduled meeting information from meeting service 521 in addition to, or in place of, receiving such information from calendaring service 518. For example, data collection module 514 may use the ZOOM or TEAMS API to retrieve a meeting's start time, end time, title, description, list of participants, etc. using the corresponding online meeting id. Thus, in some embodiments, meeting graph service 508 can operate without accessing calendaring service 518.

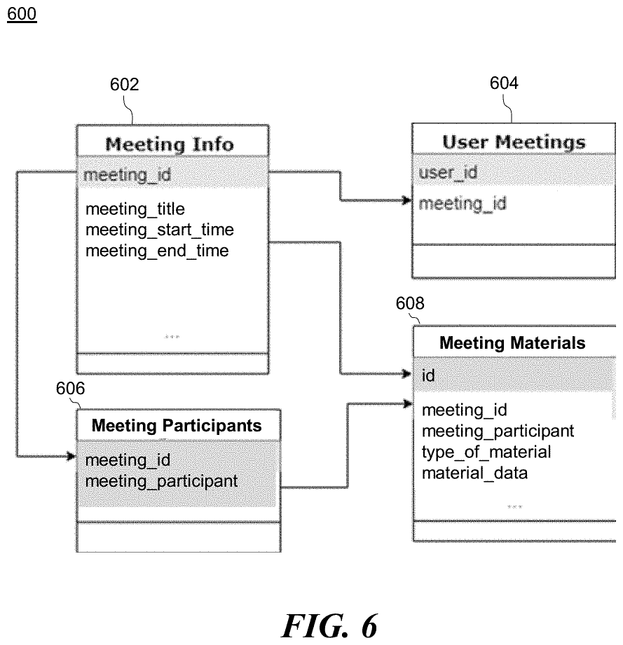

Data collection module 514 can store the scheduled meeting information and meeting materials retrieved from services 518, 519, and/or 521 within a structured database 524. In some embodiments, structured database 524 may correspond to a relational database management system such as MYSQL, POSTGRESH, ORACLE, SQLSERVER, etc. In some embodiments, structured database 524 may correspond to a storage service within cloud computing environment 504. Data collection module 514 can retrieve and store scheduled meeting information and materials for one or more users associated with one or more organizations. Data collection module 514 may transform certain types of meeting information into a form or structure suitable for storing in structured database 524. An illustrative schema that can be implemented within structured database 524 to store meeting information is described below in the context of FIG. 6.

In addition to collecting meeting materials from meeting service 521 and/or email service 519, meeting graph service 508 may also enable users to upload files associated with particular meetings. Non-limiting examples of types of files that can be uploaded by a user include meeting minutes, meeting agendas, and other documents; image files; audio files; and video files. Client-side meeting graph agent 506 may provide a UI (e.g., a file picker control that is activated by a button) for users to upload files for a given meeting. In response to a user uploading a file, meeting graph agent 506 may send a request to meeting graph service 508 that includes a unique identifier for the meeting along with the contents of the file. Meeting graph service 508 may receive the upload request and, in response, may store the contents of the file within structured database 524 in association with the meeting. In some embodiments, after a file is uploaded by a user, meeting graph service 508 may trigger graph generation module 516 to update/re-generate meeting graph data for the meeting and store the updated/re-generated meeting graph data in graph database 526. In some embodiments, meeting graph service 508 may store the contents of uploaded files to a cloud storage that is separate from structured database 524 and may store a URL or other identifier within structured database 524 that can be used to retrieve the file from cloud storage. It should be understood that meeting graphs generated according to the present disclosure can include files uploaded via the meeting graph agent 506 in addition to files uploaded via the online meeting service 521 (i.e., using file upload/sharing functionality provided by online meeting service 521).

In some embodiments, data collection module 514 can collect scheduled meeting information and meeting materials from services 518, 519, and/or 520 on a continuous or periodic basis. For example, data collection module 514 can retrieve information about meetings that occurred (e.g., were scheduled to start/end) within a given time period (“recent meeting period”). The recent meeting period can be defined, for example, as meetings that occurred within the past N days, the past N weeks, the past N months, etc. where N is a configurable parameter of data collection module 514. The recent meeting period can vary for different organizations and/or different users. For example, it maybe be configured as part of an organization's policy or a user preference.

In some embodiments, data collection module 514 can retrieve scheduled meeting information and materials from services 518, 519, and/or 521 in response to an input. For example, a user of resource access application 502 may click/tap on a meeting displayed in a calendar view or a button displayed in conjunction with a meeting, such as a button labeled “Generate Meeting Graph.” In response, meeting graph agent 506 may send a request to meeting graph service 508 that causes data collection module 514 to retrieve information about that meeting from services 518, 519, and/or 521. As one example, meeting graph agent 506 may send a request that includes a unique identifier for the meeting within calendaring service 518 which data collection module 514 can use to retrieve scheduled meeting information from calendaring service 518 and, in turn, to retrieve meeting materials from meeting service 521. As another example, meeting graph agent 506 may send a request that includes a unique identifier for the meeting with meeting service 521 which data collection module 514 can use to directly retrieve material materials from meeting service 521.

Graph generation module 516 can convert or transform the structured meeting information and materials within structured database 504 into a format suitable for storage in a graph database 526. Graph database 526 can be provided as any type of database/datastore capable of storing unstructured data objects (i.e., objects having arbitrary formats and attributes) and relationships between such objects, and of efficiently querying stored objects and relationships. Within graph database 526, data objects may be treated as nodes of a graph and relationships between data objects may be treated as vertices of the graph. In this way, meeting graph data stored in graph database 526 can be readily used to generate/render visual meeting graphs for display on client devices (e.g., on client 501). In some embodiments, graph database 526 may be provided as a triplestore, meaning a database that stores arbitrary data objects and relationships as 3-tuples or “triples” (in contrast to relational databases where data is stored within defined structured tables having a predefined set of attributes). In some embodiments, graph database 526 may correspond to an open-source graph database such as NEO4J, JENA, or D2RQ. In some embodiments, graph database 526 may correspond to a storage service within cloud computing environment 504.

Graph generation module 516 can send meeting graph data stored in graph database 526 to meeting graph agent 506, which can use the meeting graph data to generate a visual meeting graph, as described in more detail below. Graph generation module 516 can send meeting graph data to meeting graph agent 506, for example, in response to the user clicking a “Generate Meeting Graph” button. In some embodiments, meeting graph data may be pre-loaded or pre-cached on one or more clients 501. For example, meeting graph agent 506 may request meeting graph data from meeting graph service 508 when resource access application 502 launches and/or on a periodic basis thereafter. Meet graph agent 506 may store the meeting graph data to local memory where it can later be used to generate visual meeting graphs (e.g., in response to the user clicking a “Generating Meeting Graph” button).

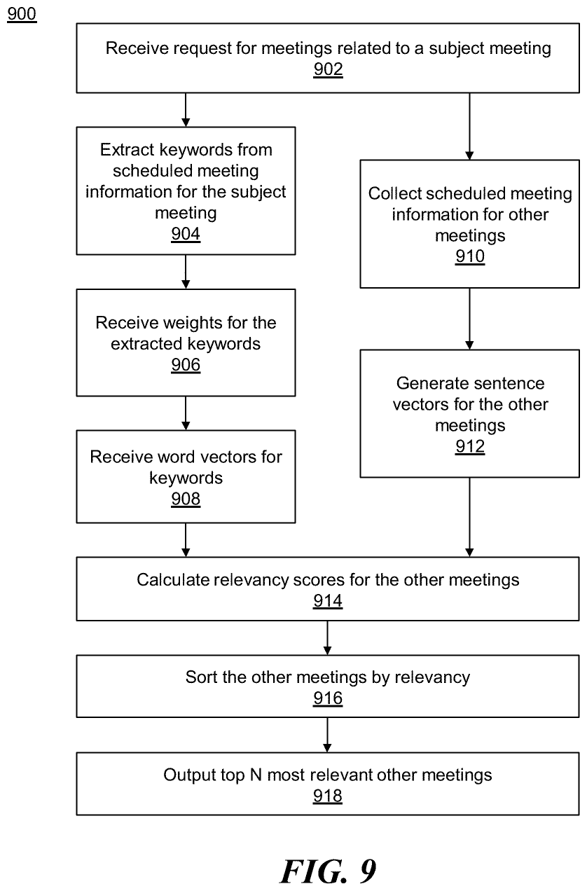

In some embodiments, graph generation module 516 can use information stored in structured database 524 to identify meetings that are related to each other (e.g., meetings associated with the same project or topic). For example, graph generation module 516 can use meeting titles, descriptions, lists of participants, and/or other scheduled meeting information retrieved from calendaring service 518 to identify meetings that are related to each other. In some embodiments, graph generation module 516 may query structured database 524 for information about meetings that occurred within a given time period (e.g., the past N months or another recent meeting period) and identify related meetings from among this cohort. In some embodiments, graph generation module 516 can utilize one or more ML algorithms to identify related meetings. An illustrative process that can be used to identify related meetings is described below in the context of FIG. 9. In some embodiments, graph generation module 516 can store identified meeting relationships in graph database 526. For example, in response to determining that two meetings are related to each other, graph generation module 516 may store a triple within graph database 526 that represents a relationship (i.e., a vertex or “side”) between the two meetings (i.e., nodes).

In some embodiments, graph generation module 516 can identify related meetings on a continuous or periodic basis. In some embodiments, graph generation module 516 can identify related meetings in response to (e.g., subsequent to) scheduled meeting information being retrieved from calendaring service 518. In some embodiments, graph generation module 516 can identify related meetings in response to an input. For example, a user of resource access application 502 may click/tap on a button (e.g., a button labeled “Show Related Meetings”) displayed in conjunction with a visual meeting graph for a particular meeting. In response to the user clicking/tapping the button, meeting graph agent 506 may send a request to meeting graph service 508 that causes graph generation module 516 to execute a process for identifying meetings related to the particular meeting. The request can include an identifier that can be used to retrieve meeting information for the particular meeting from structured database 524. Graph generation module 516 may send updated/new meeting graph data to meeting graph agent 506, causing meeting graph agent 506 to update the visual meeting graph such that it displays the related meetings (if any).

In some embodiments, some or all of the processing described for meeting graph service 508 can be implemented within resource access application 502. For example, data collection module 514 and/or graph generation module 516 can be implemented as sub-modules of resource access application 502 and configured to execute on client 501 (rather than within cloud computing environment 504).

Turning to the client 501, meeting graph agent 506 can include various UI controls 510 that enable a user to readily access meeting materials and other meeting information for meetings the user was invited to (e.g., meetings that appear in the user's calendar application 530). For example, UI controls 510 can include buttons or other controls for generating visual meeting graphs for particular meetings. In response to the user clicking/tapping on such a button, meeting graph agent 506 can send a message to meeting graph service 508 requesting meeting graph data for a corresponding meeting. Meeting graph service 508 can handle the request by collecting meeting materials and generating meeting graph data therefrom, as previously described. UI controls 510 may also include controls used to render visual meeting graphs based on meeting graph data returned from meeting graph service 508.

As another example, UI controls 510 can include a button or other type of control for requesting information about meetings related to a particular meeting. In response to the user clicking/tapping on such a button, meeting graph agent 506 can send a message to meeting graph service 508 requesting meeting information related to the particular meeting. Meeting graph service 508 can handle the request by identifying related meetings using one or more ML algorithms, as previously discussed.

As another example, UI controls 510 can include controls (e.g., a file picker control that is activated by a button) for uploading files associated with particular meetings. In response to the user uploading a file at client 501 using these controls, meeting graph agent 506 can send a message to meeting graph service 508 causing meeting graph service 508 to store the contents of the file in association with a particular meeting (e.g., within structured database 524). Thus, UI controls 510 may enable a user to upload user-defined meeting minutes or other meeting materials to meeting graph service 508 such that the uploaded materials are included in meeting graphs subsequently generated by meeting graph service 508 and/or displayed by meeting graph agent 506.

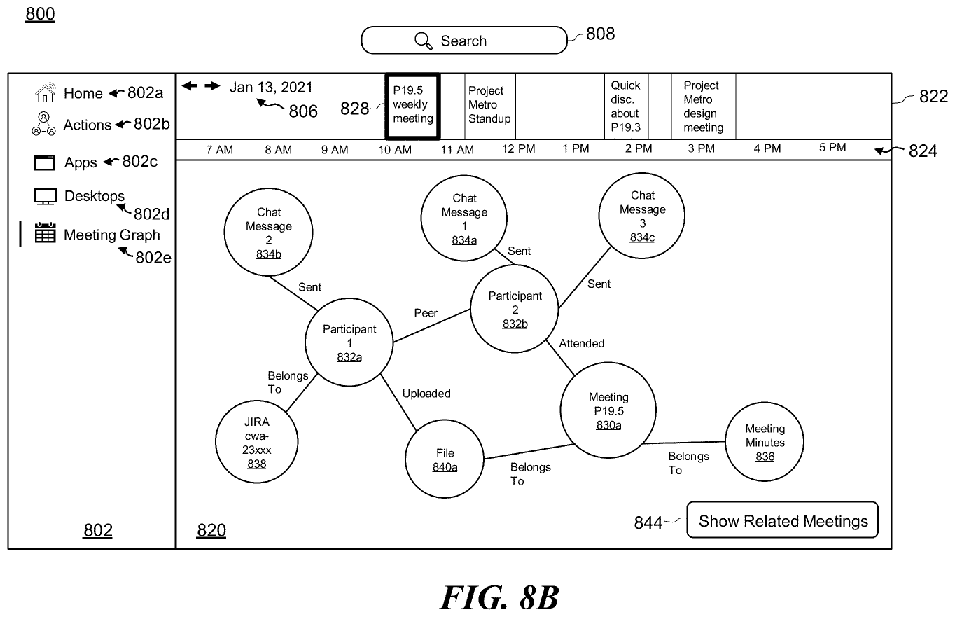

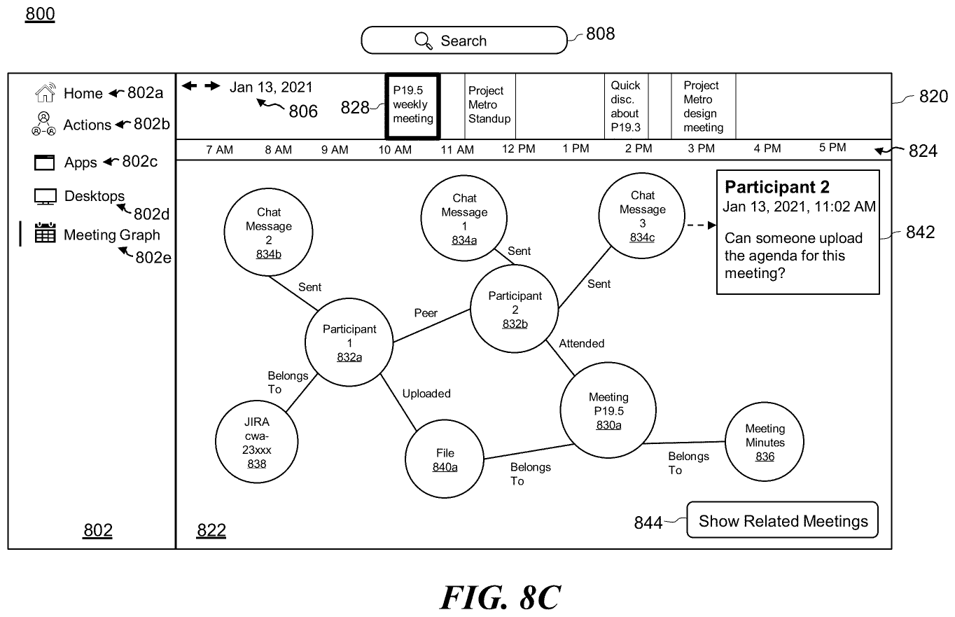

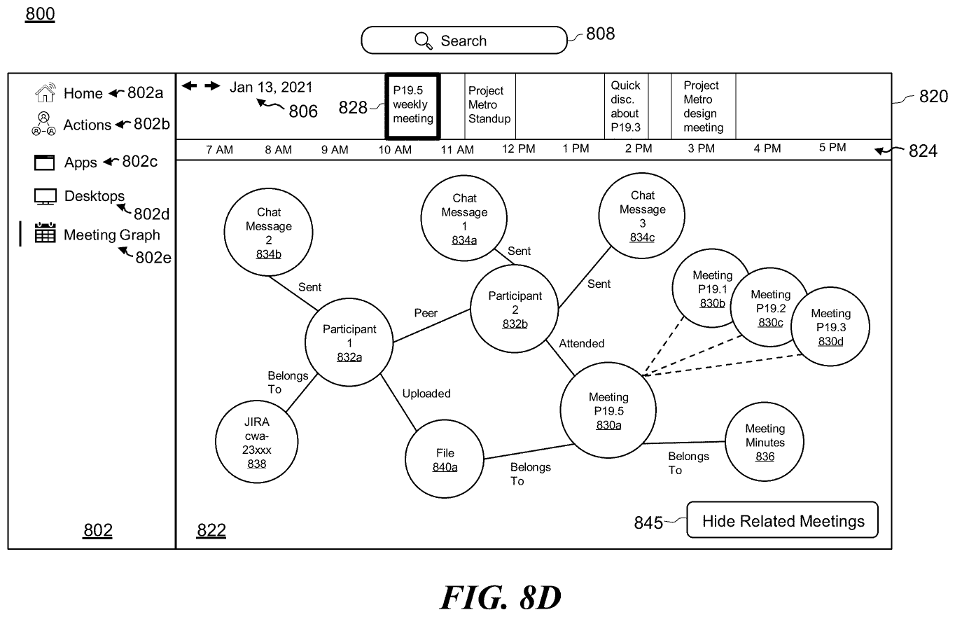

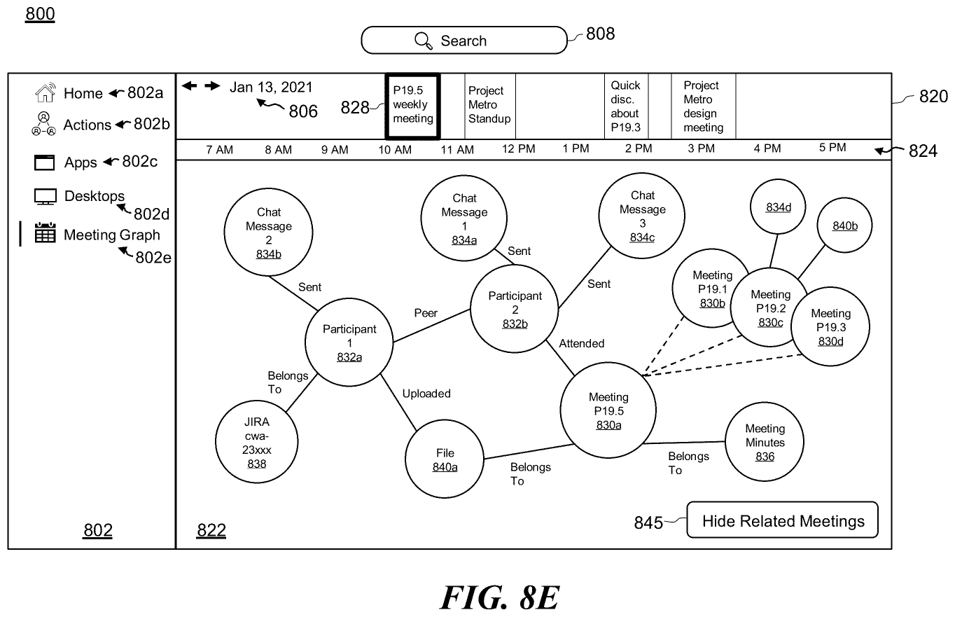

These and other examples of UI controls 510 that can be provided by meeting graph agent 506 are shown and described below in the context of FIGS. 8A-8E.

In the embodiment of FIG. 5, meeting graph agent 506 is shown as a component of a resource access application 502. Thus, for example, UI controls 510 for accessing meeting materials may be provided within resource access application 502. In other embodiments, meeting graph agent 506 may be implemented as a plug-in or extension to calendar application 530 and/or meeting application 534 such that UI controls 510 may be accessed within these applications.

Turning to FIG. 6 and with continued reference to FIG. 5, a database schema 600 may correspond to a portion of a schema used within structured database 524. The illustrative schema 600 includes a meeting information table 602, a user meetings table 604, a meeting participants table 606, and a meeting materials table 608.

Meeting information table 602 can store scheduled meeting information retrieved from, for example, calendaring service 518 for one or more meetings. In the example shown, meeting information table 602 includes the following attributes (or “columns”): a unique identify for a meeting (“meeting_id”), the meeting's title (“meeting_title”), the meeting's start time(“meeting_start_time”), and the meeting's end time (“meeting_end”). The meeting_id attribute, which may be a unique key of table 602, may correspond to a unique identifier of the meeting within calendaring service 518 or within online meeting service 521.

User meetings table 604 can store information used to identify, for a given row in the meeting information table 602, which user that information was collected for. In other words, when a user clicks the “Generate Meeting Graph” button for a particular meeting, the scheduled information for that meeting can be stored as a new row in the meeting information table 602 and row may be inserted into the user meetings table 604 to associate/link the new row to the user within the meeting information table 602. In more detail, user meetings table 604 can include an attribute to identify the user (“user_id”) and an attribute to identify the meeting (“meeting_id”). The user_id and meeting_id attributes may collectively constitute a unique key of user meetings table 604. The meeting_id attribute of user meetings table 604 may be a foreign key that references the meeting_id attribute of the meeting information table 602.

As previously discussed, meeting graph service 508 can collect meeting materials for many users within the same organization. It is likely that two or more such users may be invited to the same meeting (i.e., have the same meeting appear on their calendar). User meetings table 604 can be used to associate/link multiple users to the same collected meeting information 602 and, in turn, to the same collected meeting materials 608. For example, if a user clicks the “Generate Meeting Graph” for a particular meeting, data collection module 514 can check if the corresponding meeting id already exists within the meeting information table 602 and, if it does, data collection module 514 can link the user to the existing row within the meeting information table 602 instead of collecting duplicate information for the same meeting. This can lead to a significant reduction in the processing and storage resources consumed by meeting graph service 508.

Meeting participants table 606 can be used to store the list of participants for one or more meetings. As previously discussed, the list of participants of a meeting can be retrieved from calendaring service 518 as part of the scheduled meeting information. In the example shown, meeting participants table 606 includes a “meeting_id” attribute corresponding to a unique meeting identifier and a “meeting_particpant” attribute identifying a participant of that meeting by name, email address, or by other type of identifier. The meeting_id and meeting_particpant attributes may collectively constitute a unique key of the meeting participants table 606. The meeting_id attribute of meeting participants table 606 may be a foreign key that references the meeting_id attribute of the meeting information table 602.

Meeting materials table 608 can be used to store meeting materials collected for one or more meetings. In the example shown, meeting materials table 608 includes an “id” attribute, a “meeting_id” attribute that identifies the meeting for which a particular meeting material (e.g., file, meeting minutes, chat message, JIRA link, etc.) was collected, a “meeting_particpant” attribute that identifies a meeting participant that is associated with the meeting material (e.g., the name of the user that uploaded or posted the material), a “type_of_material” attribute that indicates what type of material is stored (e.g., meeting minutes versus a chat message versus a link to an external resource), and a “material_data” column that includes the contents of the collected meeting material (e.g., the contents of a file, the body of a text message, etc.). The id attribute may correspond to a unique synthetic identifier of table 608. For example, the id attribute may be implemented as an IDENTITY column in SQL SERVER or an AUTO_INCREMENT column in MYSQL. The meeting_id attribute of meeting materials table 608 may be a foreign key that references the meeting_id attribute of the meeting information table 602 and the meeting_participant attribute of meeting materials table 608 may be a foreign key that references the meeting_participant attribute of the meeting participants table 606. In some cases, the meeting_participant attribute can be blank/null indicating that the collecting meeting material is not associated with any particular user. As previously discussed, the contents of a given meeting material, such as an uploaded file, may be stored outside of the structured database (e.g., within cloud storage). In this case, the meeting_data attribute may include a URL or other information that can be used to access the externally stored meeting material contents.

The illustrative structured database tables shown in FIG. 6 can be used to efficiently query meeting information and materials based on various conditions. For example, schema 600 can be used to query for a list of all meetings a particular user has attended in a given time period or to query for a list of all materials collected for a given meeting. Schema 600 is merely illustrative and is not intended to depict a complete schema used within a structured database 524. For example, in practice, structured database 524 may include various other tables and the illustrated tables 602, 604, 606, and/or 608 may include additional attributes not shown in FIG. 6.

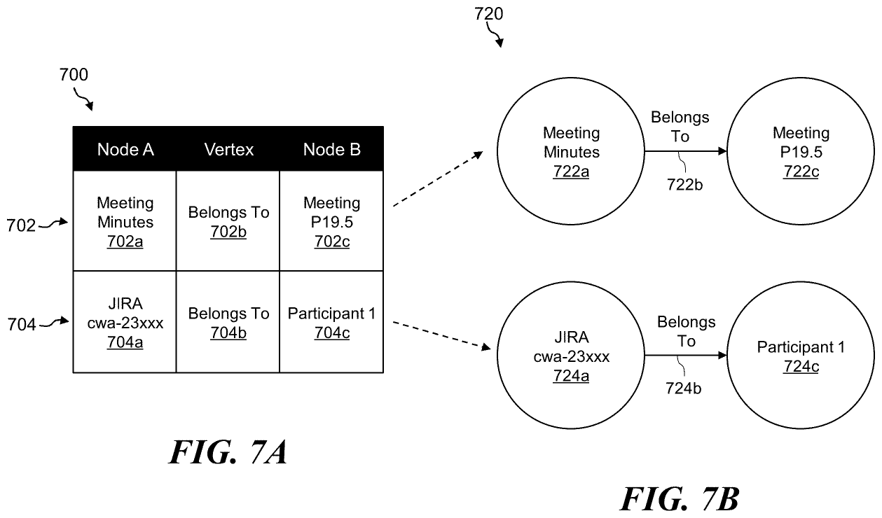

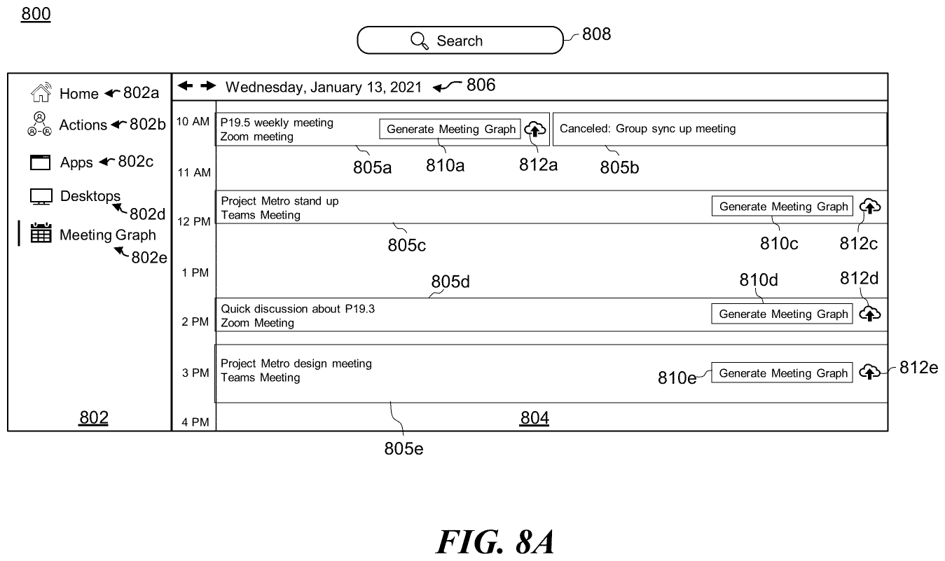

FIG. 7A shows a simple example of meeting graph data 700 that can be generated and stored within the system of FIG. 5, according to some embodiments. For example, with continued reference to FIG. 5, illustrative meeting graph data 700 may be generated by graph generation module 516—based on meeting materials collected and stored in structured database 524—and then stored in graph database 526.

The illustrative meeting graph data 700 includes a first triple 702 and a second triple 704. First triple 702 includes a first value 702a corresponding to meeting minutes, a second value 702b indicating a “Belongs To” relationship, and a third value 702c corresponding to a meeting (“Meeting P19.5”). Thus, first triple 702 may represent that particular meeting minutes belong to Meeting P19.5 (e.g., the meeting minutes may have been automatically generated by an online meeting application for Meeting P19.5).

Second triple 704 includes a first value 704a corresponding to a JIRA ticket (“cwa-23xxx”), a second value 704b indicating a “Belongs To” relationship, and a third value 704c corresponding to a meeting participant (“Participant 1”). Thus, second triple 704 may represent that JIRA ticket cwa-23xxx belongs to Participant 1 (e.g., Participant 1 may have linked this JIRA ticket to a meeting).

It should be understood that the meeting graph data shown in FIG. 7A is merely a simple example and that, in practice, meeting graph data generated according to embodiments of the present disclosure may include a large number of triples (e.g., more than 100 or more than 1,000 triples).

FIG. 7B shows a portion of a visual meeting graph 720 that can be generated from the meeting graph data of FIG. 7A. As shown, values 702a, 702c, 704a, 704c of meeting graph data 700 can be rendered/displayed as nodes (e.g., circles) 722a, 722c, 724a, 724c, respectively, within visual meeting graph 720. Values 702b, 704b of meeting graph data 700 can be rendered as vertices (e.g., lines) 722b, 724b, respectively, within visual meeting graph 720. In some embodiments, nodes corresponding to different types of meeting materials may be rendered using different visual styles. For example, node 722a corresponding to meeting minutes may be rendered in a certain color and node 724a corresponding to a JIRA ticket (or, more generally, a link to an external resource) may be rendered in a different color. The type of meeting material can be determined, for example, using the “type_of_material” attribute within meeting materials table 608 (FIG. 6).

FIGS. 8A-8B show examples of a UI 800 that can be used to efficiently access meeting materials, according to some embodiments of the present disclosure. UI 800 may be implemented within the system 500 of FIG. 5 and, more particularly, within resource access application 502 of FIG. 5. Alternatively, portions of UI 800 can be implemented within other types of applications. For example, controls for generating meeting graphs can be implemented (e.g., as a plugin or extension) within a calendar application, such as calendar application 530 of FIG. 5.

Referring to FIG. 8A, the illustrative UI 800 includes a resource menu 802, a calendar view 804, date selector controls 806, and a search box 808. Resource menu 802 can include a home menu item 802a, an actions menu item 802b, a desktops menu item 802d, and a meeting graph menu item 802e. Menu items 802a-802e may also be referred to as “tabs.” A user may click/tap on menu items 802a-802e to access corresponding functionality of the resources access application. The first four menu items 802a-802d may be used to access functionality of an existing resource access application, such as access to remote applications (menu item 802c) and remote desktops (menu item 802d). The meeting graph menu item 802e can be used for generating, viewing, and interacting with meeting graphs according to the present disclosure.

In response to a user clicking/tapping the meeting graph menu item 802e, UI 800 can display calendar view 804 and date selector controls 806. Calendar view 804 can show information for meetings the user is invited to within the date range specified by the date selector controls 806. In the example of FIG. 8A, calendar view 804 includes visual representations (e.g., boxes) for meetings 805a, 805b, 805c, 805d, and 805e (805 generally). The meeting information displayed within calendar view 804 can be obtained directly from calendaring service 518, or indirectly from meeting graph service 508 or from a calendar application 530 installed on the client. In some embodiments, calendar view 804 may show meetings for the current date by default (i.e., date selector controls 806 may default to the current date).

For one or more of the displayed meetings 805, calendar view 804 can also include controls for generating meeting graphs and/or uploading meeting materials to be included in generated meeting graphs. For example, as shown in FIG. 8A, calendar view 804 can include buttons (“‘Generate Meeting Graph’ buttons”) 810a, 810c, 810d, 810e (810 generally) for generating meeting graphs for meetings 805a, 805c, 805d, 805e, respectively. Calendar view 804 can also include buttons (“upload buttons”) 812a, 812c, 812d, 812e (812 generally) for uploading files for meetings 805a, 805c, 805d, 805e, respectively. Of note, UI 800 may not include such buttons for canceled meetings, such as meeting 805b.

In response to the user clicking/tapping a “Generate Meeting Graph” button 810, meeting graph agent 506 may send a message to meeting graph service 508 requesting meeting graph data for the respective meeting. The request may include a unique identifier for the meeting. The meeting graph service 508 may generate meeting graph data using techniques previous described and return the meeting graph data to meeting graph agent 506. UI 800 may use the meeting graph data to render/display a visual meeting graph as described further below in the context of FIGS. 8B-8D.

In response to the user clicking/tapping an upload button 812, UI 800 may present a file picker or other type of UI control (not shown) to allow the user to choose a file to be uploaded. After the user chooses a file, meeting graph agent 506 may send a message to meeting graph service 508 requesting that the contents of the file be stored in association with the respective meeting. The request can include the contents of the file along with a unique identifier for the meeting. The meeting graph service 508 may store the contents of the uploaded file in structured database 524, as previous described,

FIG. 8B shows an example of a visual meeting graph that may be displayed in response to the user clicking “Generate Meeting Graph” button 810a of FIG. 8A. As shown, UI 800 can be updated to replace the calendar view 804 with graph view 820 and to add meeting selector controls 822.

Meeting selector controls 822 can include a timeline 824 and visual representations (e.g., boxes) for meetings within the date range specified by date selector controls 806 for which meeting graphs can be generated. The user can use meeting selector controls 822 to change which meeting is represented by the visual meeting graph within graph view 820. By default, the meeting for which the “Generate Meeting Graph” button 810 (FIG. 8A) was clicked/tapped is selected within meeting selector controls 822, such as indicated by highlight 828.

Graph view 820 can display visual meeting graphs, that is visual representations (e.g., circles) of meeting materials and other meeting information and visual relationships (e.g., lines) indicating the relationships between such materials/information. Such visual representations can be constructed using the meeting graph data returned from the meeting graph service 508 using, for example, techniques described above in conjunction with FIGS. 7A and 7B. In the example of FIG. 8, graph view 820 displays a visual meeting graph having a meeting node 830a, participant nodes 832a, 832b (832 generally), chat message nodes 834a, 834b, 834c (834 generally), a meeting minutes node 836, a JIRA ticket node 838, and a file node 840a. Meeting node 830a may correspond to the meeting selected within meeting selector controls 822 (i.e., the meeting indicated by highlight 828). The nodes may be connected by vertices labeled with the relationship between the nodes. For example, meeting minutes node 836 is connected to meeting node 830a by a vertex labeled “Belongs To,” indicating that the meeting minutes belong to the meeting. In some embodiments, the vertices may be rendered as directed arrows providing further indication of how the connected nodes are related to each other. As another example, file node 840a is connected to a first participant node (“Participant 1”) 832a by a vertex labeled “Uploaded,” indicating that the first Participant 1 uploaded the file. In some embodiments, it can be determined if two or more meeting participants are peers, meaning that the participants belong to a common organization, team, group, etc. In this case, the participant nodes can be connected by a vertex labeled, for example, “Peer” as illustrated by nodes 832a, 832b in FIG. 8B. Various techniques can be used to determine if participants are peers. For example, if two meeting participants report to the same manager (e.g., according to an organizational chart), then they may be determined to be peers.

In some embodiments, nodes corresponding to different types of meeting materials/information may be rendered using different visual styles. For example, participant nodes 832 may be rendered with a certain color/style ad chat message nodes 834 may be rendered with a different color/style. The type of meeting material can be determined, for example, using the “type_of_material” attribute of meeting materials table 608 of FIG. 6.

In some embodiments, a visual meeting graph displayed within graph view 820 may be rendered/generated by the graph database 526. Some graph databases—such as NEO4J, JENA, and D2RQ—include functionality to output graph visualizations in one or more data formats such as JPEG, PNG, GIF, HTML, etc. UI 800 can obtain such visualization data from the graph database 526 (either directly or indirectly via the meeting graph service 508) and render the visualization data (i.e., a visual meeting graph) within graph view 820. In some embodiments, the graph database 526 may provide a URL to access such visualization data and UI 800 can use the URL to render a visual meeting graph within graph view 820.

A user may click/tap on certain nodes within graph view 820 to access the corresponding meeting materials. For example, referring to FIG. 8C, if the user clicks/taps on chat message node 834c, graph view 820 may display details of that chat message in a pop-up window 842. The action taken by UI 800 in response to a user clicking on a node within graph view 822 may vary depending on the type of meeting material represented by the node. For example, in the case of a meeting node 830, graph view 820 may show the meeting title, description, start/end time, and other scheduled meeting information. In the case of a chat message node 834, graph view 820 may show the identity (e.g., name or email address) of the person that sent the chat message, the date and time the message was sent/received, and the body of the message as illustrated in FIG. 8C. In the case of a participant node 832, graph view 820 may show participant's full name, email address, information about the team/group the participant belongs to, information about the participant's manager(s), etc. In the case of a meeting minutes node 836, graph view 820 may show the contents of the meeting minutes, or a summary thereof with a link/URL to access the full meeting minutes. In response to the user clicking/tapping on a JIRA ticket node 838 (or, more generally, a node corresponding to external resource), UI 800 may cause the JIRA ticket to be opened in the JIRA website/app (or, more generally, to provide the user with access to the external resource). In the case of a file node 840, graph view 820 may show the contents of the file, or a summary thereof with a link/URL to access the full file contents.

The illustrative UI 800 can also include a button (“Show Related Meetings' button”) 844 or other type of control for accessing related meetings. Initially, graph view 820 may display a visual meeting graph that includes a single meeting node 830, node 830a in the example of FIGS. 8B and 8C. The user can click/tap the “Show Related Meetings” button 844 to access information about meetings related to that meeting. In some embodiments, the user may click/tap on a meeting node 830 to active the “Show Related Meetings” button 844. In response to the user clicking/tapping the “Show Related Meetings” button 844, UI 800 may cause a message to be sent to the meeting graph service 508 requesting related meeting information. The request may include a unique identifier for the meeting represented by the initial meeting node 830a. The meeting graph service 508 may identify related meeting information and respond with updated/additional meeting graph data that can be rendered by UI 800. For example, referring to FIG. 8D, meeting graph service 508 can return meeting graph data representing three related meetings, which can be rendered within graph view 822 as new meeting nodes 830b, 830c, and 830d connected to the initial meeting node 830a. The user can then click/tap on the new meeting nodes to access corresponding meeting materials. For example, in response to the user clicking/tapping new meeting node 830c, UI 800 can display a chat message node 834d and a file node 840b connected to new meeting node 830c. In some embodiments, UI 800 can also include a button (“Hidden Related Meetings' button”) 845 or other type of control to hide the related meeting information.

The UI 800 illustrated in FIGS. 8A-8E allow users to efficiently visualize and access meeting materials in convenient and centralized interface. Such meeting materials include, but are not limited to, meeting participants, the relationship of participants, chat messages sent/received by meeting participants, JIRA tickets or other external resources related to a meeting, meeting minutes, user-uploaded files, and related meeting information.

FIG. 9 shows an illustrative process 900 for identifying related meetings, according to embodiments of the present disclosure. Process 900 may be implemented, for example, within meeting graph service 508 and executed in response to meeting graph service 508 receiving a request for related meeting information from meeting graph agent 506 (e.g., in response to the user clicking a “Show Related Meetings” button).

At block 902, a request for meetings related to a given meeting (“subject meeting”) is received. The request can include a unique identifier for the meeting.

At block 904, scheduled meeting information can be retrieved for the subject meeting and one or more keywords may be extracted therefrom. The scheduled meeting information, which can include the meeting's title and description, can be retrieved structured database 524 or from calendaring service 518. To extract the keywords, the meeting's title, description, etc. can be split on words boundaries into a preliminary list of keywords, and then stop words may be filtered out to produce a list of meeting keywords.

At block 906, weights may be received for the extracted keywords. The weights may be user-defined values or default values. For example, as a default, identical weights can be assigned to each of the keywords.

At block 908, trained word vectors may be received for the extracted keywords. For example, meeting graph service 508 may have access to a repository of trained word vectors (e.g., 300-dimension word vectors) corresponding to many different words in one or more different languages. In more detail a mapping can be generated from k extracted keywords w₁, w₂, . . . , wₖ, to corresponding k word vectors v_{w1}, v_{w2}, . . . , v_{wk} as follows:

{w₁: v_{w1},w₂: v_{w2}, . . . ,wₖ:v_{wk}}

A word vector is a vector of numbers that represent the meaning of a word. The numbers in the word vector represent the word's distributed weight across dimensions. Each dimension can represent a meaning and the word's numerical weight on that dimension captures the closeness of its association with and to that meaning. Thus, the semantics of the word are embedded across the dimensions of the vector. Meeting graph service 508 can retrieve pre-trained word vectors from third parties (e.g., open source word vectors) or can generate its own trained word vectors, e.g., using the word2vec algorithm.

At block 910, scheduled meeting information can be collected for one or more other meetings (i.e., meetings other than the subject meeting). As one example, the scheduled meeting information for the other meetings can be collected by querying structured database 524 (i.e., by querying information previously collected by data collection module 514 and stored in structured database 524). The query may be limited to other meetings that occurred within a given recent meeting period, such as the last N days, weeks, or months. The query may also be limited to meetings for which the user that triggered request 902 is invited to.

At block 912, sentence vectors (or “sample vectors”) may be generated for each of the other meetings. In some embodiments, the sample vectors may be generated as 300-dimension vectors. A sample vector can be generated by first extracting a list of words from the scheduled meeting information (e.g., meeting title or description) for one of the other meetings, obtaining trained word vectors for each extracted word, and then calculating an average of the word vectors. To extract the words from scheduled meeting information for one of the other meetings, the scheduled meeting information can be split on words boundaries and then stop words may be filtered out.

For each extracted keyword, wᵢ, a trained word vector, v_{w}_{ᵢ} can be obtained (e.g., from a repository of trained word vectors). For a list of s words extracted from a given other meeting, a sample vector vₛ may be generated using the following algorithm, sometimes referred to as the sentence2vec algorithm:

$${v}_{s} = \frac{1}{\vert s \vert} {\sum }_{i}^{\vert s \vert} \frac{a}{a + p ( {w}_{i} )} {v}_{{w}_{i}}$$

where a is a constant (e.g., a parameter to the algorithm) and p(wᵢ) is an estimated probability of word wᵢ. In some embodiments, p(wᵢ) can be determined based on the number of times the word, wᵢ, appears in a sample. A mapping can be generated from the samples s₁, s₂, . . . to corresponding sample vectors vₛ₁, vₛ₂, . . . as follows:

{s₁: vₛ₁,s₂: vₛ₂, . . . }

At bock 914, relevancy scores can be calculated for each of the other meetings. To calculate the relevancy score for a given other meeting, a cosine similarity can be calculated between the corresponding sample vector vₛ (generated at block 910a or 910b) and each of the k keyword word vectors v_{w1}, v_{w2}, . . . , v_{wk} as follows:

[COS(vₛ,v_{w1}),COS(vₛ,v_{w2}), . . . ,COS(vₛ,v_{wk})].

Cosine similarity is a measure of similarity between two non-zero vectors of an inner product space. It is defined to equal the cosine of the angle between them, which is also the same as the inner product of the same vectors normalized to both have length one (1). The keyword weights, h₁, h₂, . . . , hₖ can then be applied to calculate the relevancy score, Sₛ, as a weighted sum of the cosine similarities:

Sₛ=Σᵢ^{k}COS(vₛ,v_{wi})·hᵢ

Thus, the relevancy score is a function of the keyword weights.

At blocks 916, the other meetings can be sorted by their calculated relevancy scores (e.g., in descending numerical order). The request can include a unique identifier for the meeting (i.e., a unique identifier for the meeting used by calendaring service 518 or online meeting service 521 of FIG. 5).

At block 918, the top N (e.g., N=3) most relevant other meetings can be output. For example, meeting graph service 508 may send scheduled meeting information for the top N most relevant other meetings to the meeting graph agent 506 running on a client. In some cases, meeting graph service 508 may also send collected meeting materials for these other meetings to meeting graph agent 506.

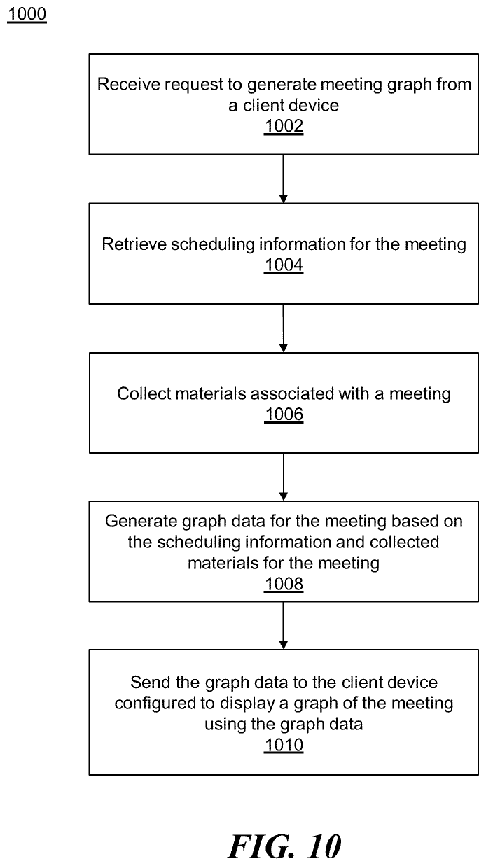

FIG. 10 shows an illustrative process 1000 providing efficient access to meeting materials, according to embodiments of the present disclosure. Process 1000 may be implemented, for example, within meeting graph service 508 and/or meeting graph agent 506 of FIG. 5.

At block 1002, a request to generate a meeting graph can be received from a client device (e.g., client 501 of FIG. 5).

At block 1004, scheduling information (e.g., title, description, and a list of participants) can be retrieved for the meeting. For example, data collection module 514 of FIG. 5 can retrieve the scheduling information from calendaring service 518.

At block 1006, various types of materials associated with the meeting can be collected, such as chat messages, files, JIRA tickets, and meeting minutes. For example, data collection module 514 of FIG. 5 may collect the meeting materials from online meeting service 521, such as TEAMS or ZOOM. In some embodiments, the meeting scheduling information and/or materials may be collected prior to the request being received (i.e., prior to execution of block 1002). In some embodiments, the meeting scheduling information and/or materials may be stored in a structured database, such as structured database 524 of FIG. 5.

At block 1008, graph data can be generated based on the retrieved scheduling information and the collected meeting materials. Techniques for generating graph data are described above in the context of FIGS. 7A and 7B, for example. In some embodiments, the graph data may be stored within a graph database, such as graph database 526 of FIG. 5.

At block 1010, the graph data can be sent to the client device, which is configured to display a graph of the meeting using the graph data. In some embodiments, a rendering of the graph may be obtained from a graph database in which the graph data is stored, and the rendering (e.g., an image, HTML document, or a URL thereto) can be provided to the client device for display.

In some embodiments, the client device may subsequently send a request for related meeting information and method 900 of FIG. 9 can be used in conjunction with FIG. 10 to provide such related meeting information to the client device.

The following examples pertain to further embodiments, from which numerous permutations and configurations will be apparent.

Example 1 includes a method including: collecting, by a first computing device, materials associated with a meeting; generating, by the first computing device, graph data for the meeting based on the collected materials, the graph data including representations of the collected materials and of relationships between the collected materials; and sending, by the first computing device, the graph data for the meeting to a second computing device, the second computing device configured to display a graph of the meeting using the graph data.

Example 2 includes the subject matter of Example 1, wherein the collecting of the materials associated with the meeting includes collecting the materials from an online meeting service, the method further including, and further includes: retrieving scheduling information for the meeting from a calendaring service from the online meeting service, wherein the generating of the graph data for the meeting is further based on the scheduling information.

Example 3 includes the subject matter of Example 2 and further includes: storing the scheduling information and the collected materials in a structured database; and storing the graph data in a graph database separate from the structured database.

Example 4 includes the subject matter of Example 3 and further includes: obtaining a rendering of the graph of the meeting from the graph database; and providing the rendering of the graph of the meeting to the second computing device, the second computing device configured to display the rendering of the graph of the meeting.

Example 5 includes the subject matter of Example 1, wherein the collected materials include information about participants of the meeting, wherein the graph data includes representations of the participants of the meeting.

Example 6 includes the subject matter of Example 1, wherein the collected materials include chat messages sent during the meeting, wherein the graph data includes representations of the chat messages.

Example 7 includes the subject matter of Example 3 and further includes receiving, by the first computing device, a request to upload a file for the meeting; and storing contents of the file in the structured database, wherein the graph data includes a representation of the file.

Example 8 includes the subject matter of Example 2, and further includes: receiving, by the first computing device, a request for information about meetings related to the meeting; retrieving scheduling information for other meetings from the calendaring service; identifying at least one of the other meetings that is related to the meeting using the scheduling information for the meeting and the scheduling information for other meetings; and sending, by the first computing device, a response including materials for the at least one of the other meetings that is related to the meeting.

Example 9 includes the subject matter of Example 8, where identifying the at least one of the other meetings that is related to the meeting includes: extracting one or more keywords from the scheduling information for the meeting; receiving trained word vectors for the one or more keywords; for each of the other meetings: generating a sentence vector based on the scheduling information for the other meeting, and calculating a similarity between the sentence vector and the trained word vectors; and identifying the at least one of the other meetings that is related to the meeting based on the calculated similarities.

Example 10 includes a system including: a processor and a non-volatile memory storing computer program code that when executed on the processor causes the processor to execute a process. The process can be operable to: collect materials associated with a meeting; generate graph data for the meeting based on the collected materials, the graph data including representations of the collected materials and of relationships between the collected materials; and send the graph data for the meeting to a client device, the client device configured to display a graph of the meeting using the graph data.

Example 11 includes the subject matter of Example 10, wherein the collecting of the materials associated with the meeting includes collecting the materials from an online meeting service, the process further operable to: retrieve scheduling information for the meeting from a calendaring service from the online meeting service, wherein the generating of the graph data for the meeting is further based on the scheduling information.

Example 12 includes the subject matter of Example 11, wherein the process is further operable to: store the scheduling information and the collected materials in a structured database; and store the graph data in a graph database separate from the structured database.

Example 13 includes the subject matter of Example 12, the process further operable to: obtain a rendering of the graph of the meeting from the graph database; and provide the rendering of the graph of the meeting to the client device, the client device configured to display the rendering of the graph of the meeting.

Example 14 includes the subject matter of Example 10, wherein the collected materials include information about participants of the meeting, wherein the graph data includes representations of the participants of the meeting.

Example 15 includes the subject matter of Example 10, wherein the collected materials include chat messages sent during the meeting, wherein the graph data includes representations of the chat messages.

Example 16 includes the subject matter of Example 10, the process further operable to: receive a request to upload a file for the meeting; and store contents of the file in the structured database, wherein the graph data includes a representation of the file.

Example 17 includes the subject matter of Example 11, the process further operable to: receive a request for information about meetings related to the meeting; retrieve scheduling information for other meetings from the calendaring service; identify at least one of the other meetings that is related to the meeting using the scheduling information for the meeting and the scheduling information for other meetings; and send a response including materials for the at least one of the other meetings that is related to the meeting.

Example 18 includes the subject matter of Example 17, where identifying the at least one of the other meetings that is related to the meeting includes: extracting one or more keywords from the scheduling information for the meeting; receiving trained word vectors for the one or more keywords; for each of the other meetings: generating a sentence vector based on the scheduling information for the other meeting, and calculating a similarity between the sentence vector and the trained word vectors; and identifying the at least one of the other meetings that is related to the meeting based on the calculated similarities.

Example 19 includes the subject matter of Example 18, wherein calculating the similarity between the sentence vector and the trained word vectors includes calculating a cosine similarity.

Example 20 includes a non-transitory computer readable medium storing program instructions that are executable to: collect materials associated with a meeting; generate graph data for the meeting based on the collected materials, the graph data including representations of the collected materials and of relationships between the collected materials; and send the graph data for the meeting to a client device, the client device configured to display a graph of the meeting using the graph data.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the specification to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method comprising:
collecting, by a first computing device, materials associated with a meeting;
generating, by the first computing device, graph data for the meeting based on the collected materials, the graph data including representations of the collected materials and of relationships between the collected materials; and
sending, by the first computing device, the graph data for the meeting to a second computing device, the second computing device configured to display a graph of the meeting using the graph data.

2. The method of claim 1, wherein the collecting of the materials associated with the meeting includes collecting the materials from an online meeting service, the method further comprising:
retrieving scheduling information for the meeting from a calendaring service from the online meeting service, wherein the generating of the graph data for the meeting is further based on the scheduling information.

3. The method of claim 2, further comprising:
storing the scheduling information and the collected materials in a structured database; and
storing the graph data in a graph database separate from the structured database.

4. The method of claim 3, further comprising:
obtaining a rendering of the graph of the meeting from the graph database; and
providing the rendering of the graph of the meeting to the second computing device, the second computing device configured to display the rendering of the graph of the meeting.

5. The method of claim 1, wherein the collected materials include information about participants of the meeting, wherein the graph data includes representations of the participants of the meeting.

6. The method of claim 1, wherein the collected materials include chat messages sent during the meeting, wherein the graph data includes representations of the chat messages.

7. The method of claim 3, further comprising:
receiving, by the first computing device, a request to upload a file for the meeting; and
storing contents of the file in the structured database,
wherein the graph data includes a representation of the file.

8. The method of claim 2, further comprising:
receiving, by the first computing device, a request for information about meetings related to the meeting;
retrieving scheduling information for other meetings from the calendaring service;
identifying at least one of the other meetings that is related to the meeting using the scheduling information for the meeting and the scheduling information for other meetings; and
sending, by the first computing device, a response including materials for the at least one of the other meetings that is related to the meeting.

9. The method of claim 8, where identifying the at least one of the other meetings that is related to the meeting includes:
extracting one or more keywords from the scheduling information for the meeting;
receiving trained word vectors for the one or more keywords;
for each of the other meetings:
generating a sentence vector based on the scheduling information for the other meeting, and
calculating a similarity between the sentence vector and the trained word vectors; and
identifying the at least one of the other meetings that is related to the meeting based on the calculated similarities.

10. A system comprising:
a processor; and
a non-volatile memory storing computer program code that when executed on the processor causes the processor to execute a process operable to:
collect materials associated with a meeting;
generate graph data for the meeting based on the collected materials, the graph data including representations of the collected materials and of relationships between the collected materials; and
send the graph data for the meeting to a client device, the client device configured to display a graph of the meeting using the graph data.

11. The system of claim 10, wherein the collecting of the materials associated with the meeting includes collecting the materials from an online meeting service, the process further operable to:
retrieve scheduling information for the meeting from a calendaring service from the online meeting service, wherein the generating of the graph data for the meeting is further based on the scheduling information.

12. The system of claim 11, wherein the process is further operable to:
store the scheduling information and the collected materials in a structured database; and
store the graph data in a graph database separate from the structured database.

13. The system of claim 12, the process further operable to:
obtain a rendering of the graph of the meeting from the graph database; and
provide the rendering of the graph of the meeting to the client device, the client device configured to display the rendering of the graph of the meeting.

14. The system of claim 10, wherein the collected materials include information about participants of the meeting, wherein the graph data includes representations of the participants of the meeting.

15. The system of claim 10, wherein the collected materials include chat messages sent during the meeting, wherein the graph data includes representations of the chat messages.

16. The system of claim 12, the process further operable to:
receive a request to upload a file for the meeting; and
store contents of the file in the structured database,
wherein the graph data includes a representation of the file.

17. The system of claim 11, the process further operable to:
receive a request for information about meetings related to the meeting;
retrieve scheduling information for other meetings from the calendaring service;
identify at least one of the other meetings that is related to the meeting using the scheduling information for the meeting and the scheduling information for other meetings; and
send a response including materials for the at least one of the other meetings that is related to the meeting.

18. The system of claim 17, where identifying the at least one of the other meetings that is related to the meeting includes:
extracting one or more keywords from the scheduling information for the meeting;
receiving trained word vectors for the one or more keywords;
for each of the other meetings:
generating a sentence vector based on the scheduling information for the other meeting, and
calculating a similarity between the sentence vector and the trained word vectors; and
identifying the at least one of the other meetings that is related to the meeting based on the calculated similarities.

19. The system of claim 18, wherein calculating the similarity between the sentence vector and the trained word vectors includes calculating a cosine similarity.

20. A non-transitory computer-readable medium storing program instructions that are executable to:
collect materials associated with a meeting;
generate graph data for the meeting based on the collected materials, the graph data including representations of the collected materials and of relationships between the collected materials; and
send the graph data for the meeting to a client device, the client device configured to display a graph of the meeting using the graph data.
